(19) United States
(12) Patent Application Publication
(10) Pub. No.: US 2017/0108193 A1
(43) Pub. Date: Apr. 20, 2017

(54) ILLUMINATING DEVICE

(71) Applicants: Werner FAERBER, St. Georgen (AT); Wolfgang TROIS, Turnau (AT)

(72) Inventors: Werner FAERBER, St. Georgen (AT); Wolfgang TROIS, Turnau (AT)

(21) Appl. No.: 15/300,644

(22) PCT Filed: Mar. 31, 2015
(86) PCT No.: PCT/AT2015/050085

§ 371 Date: Sep. 29, 2016

(30) Foreign Application Priority Data
Mar. 31, 2014 (AT) A 50233/2014

(51) Int. Cl. F21V 3/04; F21V 7/00; F21V 7/22

(52) U.S. Cl. CPC F21V 3/049; F21V 3/0436; F21V 7/22; F21V 7/00; F21Y 2115/10

(57) ABSTRACT

The invention relates to an illuminating device (1) comprising a housing (2), reflecting areas (3) on or in the housing (2), at least one illuminating means (4) and a covering (5) with one at least partially transparent material, said illuminating means (4) are arranged inside the housing (2) and the covering (5) is maintained on the housing (2). According to the invention, at least one illuminating means (4) is designed as an LED and the covering (5) comprises at least one flat element, in particular a plastic element, which modifies a radiation characteristic of the light emitted by the at least one LED.

The invention relates to an illuminating device which comprises a housing, reflective zones on or in the housing, at least one illuminating means and a cover with an at least partially transparent material, wherein the illuminating means is arranged inside the housing and the cover is held on the housing.

In recent times, conventional light bulbs and halogen light bulbs have been increasingly replaced by light-emitting diodes (LEDS) as a result of legislative measures, among other reasons. In terms of the performance provided, LEDs are more energy efficient and also more powerful than the illuminating means used conventionally for many decades. AT 508735 A1 has already successfully proposed, for a conventional illuminating means such as a halogen light bulb, concentrating the light in a desired region by arrangement of a rear-side reflector and thus increasing a power density, but the performance of an LED light source with a plurality of LEDs, for example, cannot be achieved with measures of this type.

Even though LEDs work energy-efficiently while providing a high output, there are also new challenges posed by the use of LEDs. Firstly, LEDs have the problem of a massive concentration of light in the light-emitting region due to a point emission of light. The result is a low homogeneity of the light distribution exiting from an LED.

Another problem associated with LEDs are the high glare values. As a result of the small emitting area and the highly concentrated point emission of light, the human eye is placed under significant strain.

The design and the concentrated emission of light in the case of LEDs also often mean that special measures are necessary in order to establish a suitable light emission. For example, at visual display unit workstations, both the direct glare of the light emission opening and also the reflected glare at the workstation as well as the intensity on the visual display unit must lie below specific values defined in standards. In order to achieve this, mechanical apertures are often used, as a consequence of which a desired glare reduction is achieved, but ultimately a portion of the supplied light is also sacrificed and/or an efficiency of the lamp decreases.

The object of the invention is to specify an illuminating device of the type named at the outset with which the aforementioned disadvantages can be eliminated.

The object is attained according to the invention if, in the case of an illuminating device of the type named at the outset, the at least one illuminating means is embodied as an LED, and if the cover comprises at least one flat element, particularly a plastic element, which modifies an emission characteristic of the light emitted by the at least one LED.

Over the course of the invention, it was found that, when combining a lighting element of one or more LEDs with reflective zones on the inner side of a housing and with a cover, the intensity of the light exiting the illuminating device can be adjusted in a targeted manner. Reflective zones on the inner side of a housing are known per se. However, it is surprising that this in combination with the cover leads to advantages in terms of lighting technology. As a result of the cover, a portion of the light emitted by the one or more LEDs is reflected again, so that said light reaches the reflective zones, from where it is reflected once more. Even though a light distribution of an LED is relatively narrow and, depending on the design of the housing, no emitted light initially strikes the reflective zones, these zones subsequently prove to be advantageous during multiple reflections of the light inside the housing, as the light is distributed in a particularly even, and therefore homogeneous, manner by means of the repeated reflection. The disadvantageous effects known from the prior art, such as low homogeneity or the very highly concentrated emission of light, are thus eliminated. With the cover, it is also achieved that the homogenized light or evenly distributed light intensity can also be adjusted with regard to the emission from the illuminating device. Optimal lighting conditions can thus be created respectively for each application. Thus, not only can an individual light distribution be achieved, a glare reduction can thus also be attained at the same time without the need for additional elements. The light can therefore be fully utilized without having to accept disadvantageous limitations.

The provided flat element is preferably embodied on at least one surface with a texture having ridges and recesses, the dimensions of which are larger than a wavelength of the emitted light. In particular, this element can be a flat plastic element that comprises on the surface a zig zag texture in the form of a plurality of grooves which are triangular in cross-section. The individual grooves, which can be for example imprinted in a film with a roller or an embossing element, act like prisms. If the cover is only composed of the flat plastic element, the element is typically arranged such that the grooves or prisms are on the outer side. The inner side is then normally embodied in a smooth and partially reflective manner. In combination with the zones having a reflective effect, which for example can be introduced into a plastic material by means of special finishing techniques, the prisms cause repeated reflections so that the initially narrow and highly concentrated light beam of the light emission from an LED can be distributed homogeneously over the entire area of the cover. It is thereby also possible to arrange the cover with the prisms facing inwards. Depending on the desired lighting situation, the prisms can have different textures.

Alternatively or additionally, it can also be provided that the flat element, which can be made of glass or a transparent plastic, is embodied in sections with non-transparent regions, the dimensions of which are larger than the wavelength of the emitted light. The non-transparent regions can thereby be arranged in and/or on the flat element. In particular, it can be provided that the non-transparent regions are arranged in a regular pattern. It is also possible that particles are introduced into and/or attached to the cover, wherein the particles can have an inhomogeneous distribution in and/or on the film. The particles have average dimensions that are larger than the average wavelength of the light. The particles can thereby have a specific color.

By means of an arrangement of non-transparent regions in zones or sections, the homogenized light can be emitted at precisely the points where this is necessary. In other words: the light can exit in a geometrically patterned manner. The non-transparent regions can thereby be made of a reflecting material, for example silver or aluminum. The individual regions can then act as additional reflectors that can interact with the reflective zones and with the prism texture. It is also possible that the non-transparent regions are made of a non-reflective material. The choice of material and the arrangement and size of the non-transparent regions can be used to pattern in a predetermined manner the light exiting from the illuminating device and to set desired light intensities and emission characteristics.

The cover is normally embodied to be relatively thin and typically has a thickness of less than 1 mm, preferably less than 500 μm. Covers of this type can then be present in the form of films. If made from a plastic, the cover can also possibly be bendable or flexible. The films are normally colorless, but can also be embodied in color depending on the application.

Advantageously, multiple illuminating elements are provided, wherein the illuminating elements are embodied respectively as LEDs and wherein the LEDs are arranged in a tube. The tube can be attached on the inside of the housing.

Particularly for the purpose of accommodating a lighting device embodied in a tube-shape, it is expedient if the housing is embodied in cross-section with a semicircular mount for a lighting device to which lateral legs with a parabolic profile attach. The legs can in this case accommodate the cover detachably. This can occur, for example, if the legs are embodied at their end side with horizontal projections for accommodating the cover. The cover can then be inserted as needed or can be replaced by another cover if a lighting pattern or light distribution is to be modified.

The reflective zones on or in the housing can be implemented in different ways. It is possible to arrange a reflective insert in the housing. However, it is more expedient if the housing itself is already embodied in a reflective manner, since additional components can then be omitted. For this purpose, the housing can be coated on the inner side with a reflective material, for example. It is more advantageous if the housing is made of aluminum, as there is then no need for a coating. Essentially, it is thereby expedient if a reflection on an inner side of the housing is more than 90%, in particular more than 95%.

Additional features, advantages and effects of the invention follow from the exemplary embodiments described below. The drawings which are thereby referenced show the following:

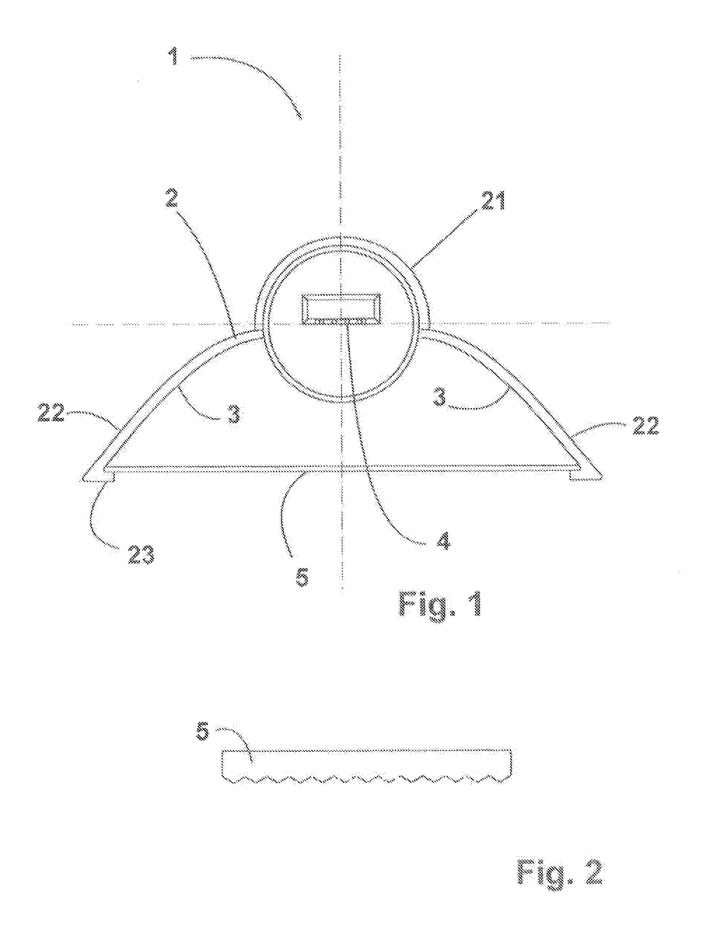

FIG. 1 An illuminating device in cross-section;

FIG. 2 A cover in cross-section;

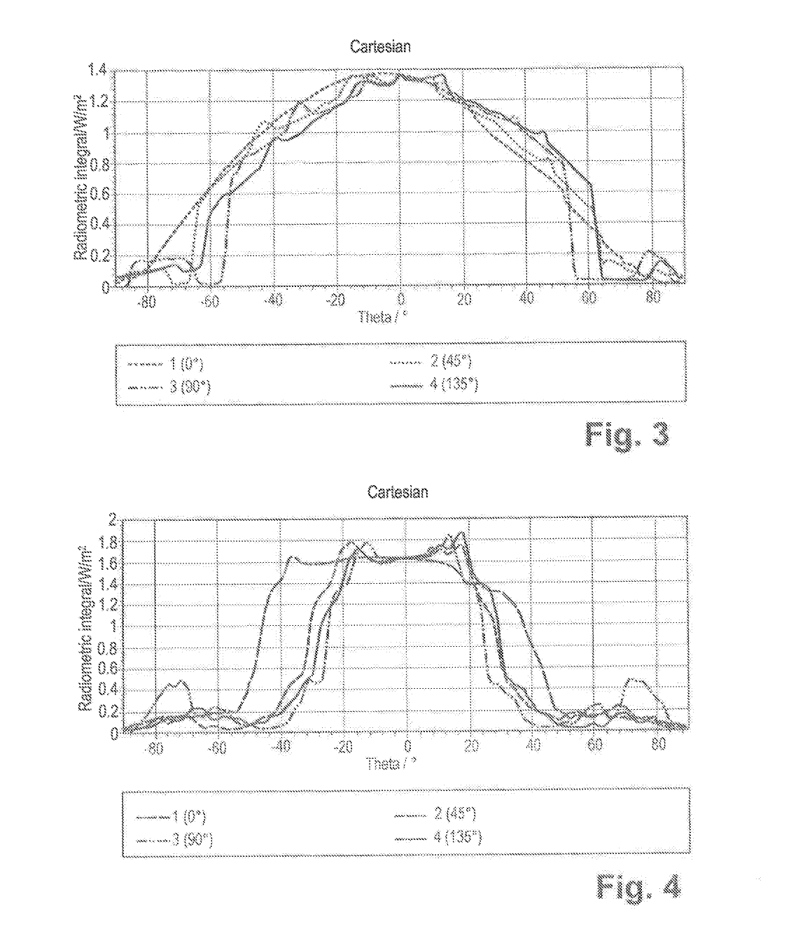

FIGS. 3 and 4 Light distribution diagrams for an illuminating device with a cover made of glass and a cover made of plastic film;

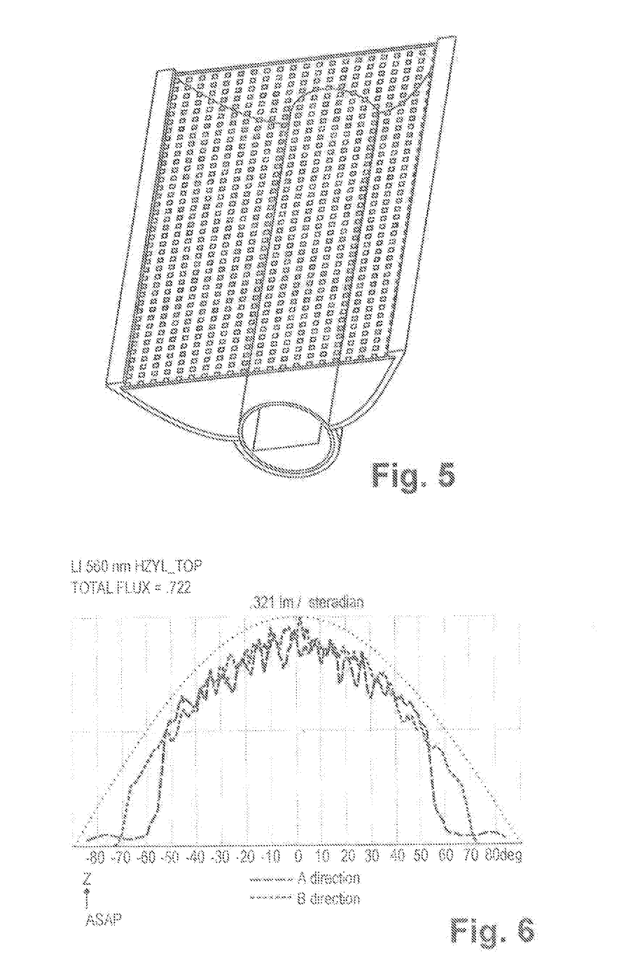

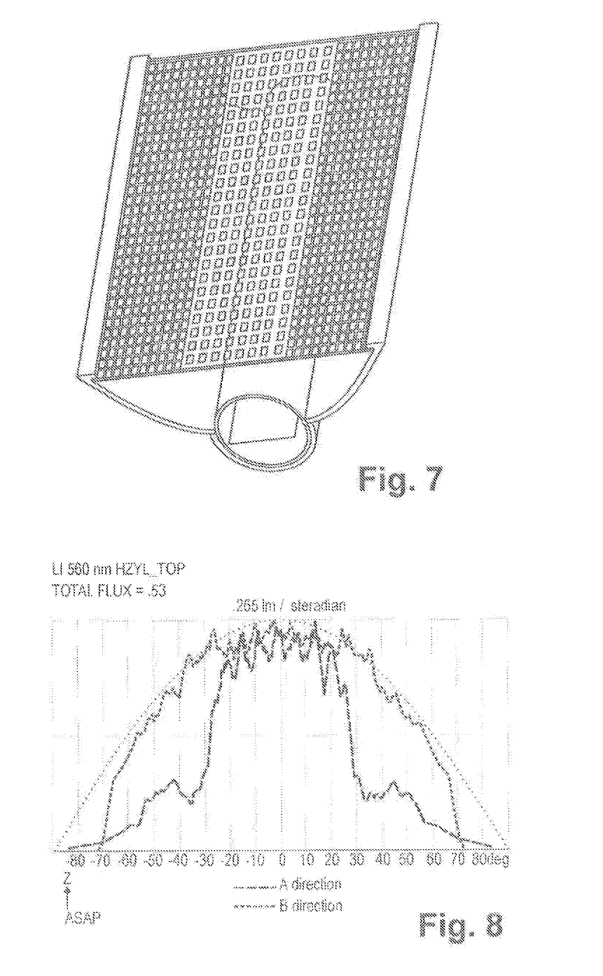

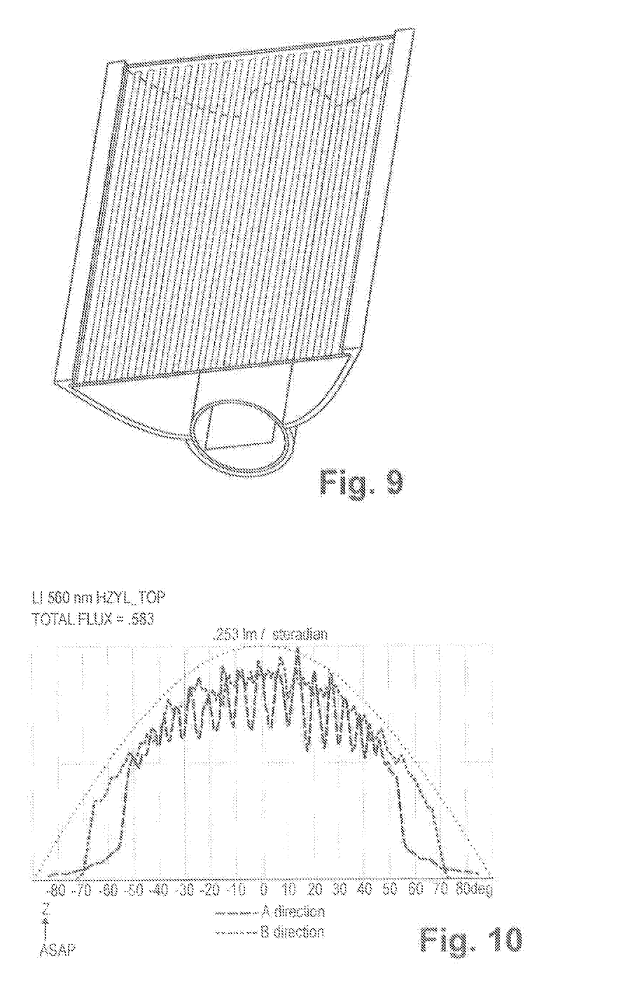

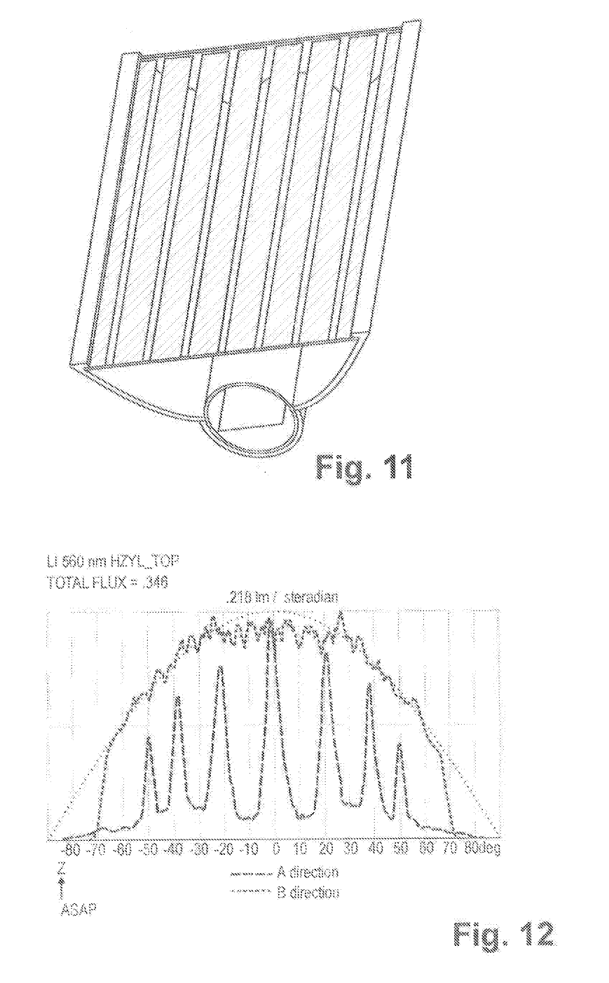

FIGS. 5 through 12 Different illuminating devices with the associated light distribution curves.

In FIG. 1, an illuminating device 1 according to the invention is illustrated in cross-section. The illumination device 1 comprises a housing 2. The housing 2 can essentially be made of any desired materials. Preferably, the housing is made of aluminum or an aluminum alloy. The housing 2 is then lightweight on the one hand and on the other hand can be embodied with a high-gloss finish on the inner side. The housing 2 can also be embodied with one or more openings, for example, if light is to be projected onto a ceiling or other special lighting situations are desired. This can be a plurality of smaller openings, but can also be a slit on the top side or the like.

The housing 2 is divided into multiple sections, namely a top-side mount 21 and lateral legs 22 which connect to the top-side mount 21. The top-side removal 21 connect. The top-side mount 21 is embodied as a semicircle in cross-section. A radius of the mount 21 is normally sized according to the diameter of a tube that has a plurality of LEDs and is to be accommodated. A similar situation applies if a printed circuit board having one or more LEDs is provided; in this case, the mount 21 is adapted accordingly to the printed circuit board. The legs 22, however, are embodied with a roughly parabolic profile in cross-section. At the bottom-side ends of the legs 22, projections 23 are provided which allow a cover 5 to be inserted. The projections 23 are embodied in one piece with the legs 22, and the legs are in turn embodied in one piece with the top-side mount 21, as a result of which the housing 2 can be manufactured from a single region. Due to the highly reflective inner regions, highly reflective zones 3 are present in the region of the legs 22, particularly on the inner side of the housing 2. In the top-side region or the mount 21, a tube with a plurality of illuminating means 4 is accommodated, which means are embodied as LEDs.

The LEDs do not need to be arranged in a tube, but rather can also be arranged on a printed circuit board or another suitable base, wherein one or more LEDs can be provided. Regardless of the type of the arrangement of the LEDs (tube, printed circuit board, etc.), the legs 22 are thereby coordinated in terms of their alignment and curvature such that at least 93%, preferably at least 95%, particularly more than 97% of the light emitted directly by the one or more LEDs ultimately strikes the upper side of the cover 5 opposite the one or more LEDs. Normally, no other elements are thereby arranged between the one or more LEDs and the cover 5.

The cover 5 is embodied as a flat element that normally extends across an entire length of the illuminating device 1 and closes the housing 2 towards the back. The cover 5 can essentially be made of any desired transparent material. Glass or a transparent plastic such as polycarbonate or poly(methyl methacrylate) can also be used. Transparent plastics are preferred, as they can be used to easily adapt the cover 5 for special application cases. If the cover 5 is made of an at least partially transparent plastic, a typical thickness is 200 μm to 800 μm. It is also possible that the cover 5 is made from multiple plastic films that are connected to one another or can be spaced apart from one another.

In the interaction with the reflective zones 3 of the housing 2 and in the emission from the one or more illuminating means 4, the cover 5 is of critical importance with regard to the light emitted by the illuminating device 1. For this purpose, the cover 5 is textured in a targeted manner. This texturing can in particular be constituted by a surface of the cover 5 embodied with recesses and ridges. A corresponding cover 5 is illustrated in cross-section in FIG. 2. The cover 5 is thereby positioned in the illuminating device 1 such that the zig zag texture is directed downwards. By means of the zig zag texture, a texture is formed which causes the cover 5 or the plastic film to act on one side like a plurality of prisms, wherein the location, size, spacing and geometric positioning of these zig zag elements relative to one another are embodied accordingly. Rays of light that strike these textures can, depending on the angle of incidence, be deflected or scattered or exit downwards or be reflected upwards (in this respect, the illustration in FIG. 2 should only be considered to be a schematic drawing). This is illustrated in FIGS. 3 and 4. FIG. 3 shows a light intensity over the exit angle for an illuminating device 1, wherein the cover 5 is made of a conventional glass that does not comprise any texturing and, in particular, does not alter an emission characteristic of the impinging light. As can be seen, the light intensity is the highest in the region around 0° and decreases towards the sides. In FIG. 4, measurement data are shown for the same illuminating device 1, wherein the cover 5 made of glass has been replaced by a 300-μm thick plastic film that is made of polycarbonate and has the noted zig zag texture. As can be seen from FIG. 4, the light intensity across the angle is modified by the use of the film with the texturing. Depending on the measuring angle, the light intensity is markedly higher in the region from approximately ±20° to ±50° and, above all, mostly consistent. The light intensity decreases dramatically to the sides. From this, it follows that the light intensity can be homogeneously focused at a high level in the center with the texturing of the film on the surface, for example by means of embossing or rolling. On the side, however, where a glare reduction would normally need to be applied, only small light intensities can be found, as a consequence of which a separate glare reduction is unnecessary.

In addition to the structural adaptation of a cover 5 or film, or possibly of a textured glass, another possibility in the targeted modification of the light intensity in the interaction of the cover 5 with the reflective zones 3 is to embody the flat element or possibly a film in sections with non-transparent regions. The non-transparent regions can be made of materials that are highly reflective, such as silver or aluminum. Corresponding textures can be easily applied using a printing method, particularly if a film or cover 5 made of plastic is used.

It is also possible to integrate corresponding textures in the cover 5 during the production of a film or cover 5. In addition to highly reflective regions, or as an alternative thereto, regions can be provided which are made of non-reflective materials, which depends on the specific application.

An embodiment of the zig zag texture is not limited to the specific illustration in FIG. 2, but rather also includes for example an undulating shape that can, particularly with regard to a homogeneity of the light, prove to be advantageous. On the zig zag texture, which can also be asymmetrical in cross-section, a reflective material can also be applied to one part of the outer flanks if highly asymmetrical lighting conditions are desired. Furthermore, on the smooth side of the cover according to FIG. 2, sloped or self-supporting surfaces can also be arranged, which can for example be achieved with 3D printing.

In FIG. 5 through 12, multiple examples of an illuminating device 1 with partially non-transparent regions are illustrated. In addition, measurement curves are also shown in which individual light intensities can be seen. Non-transparent regions are formed from small reflectors made of silver which are imprinted onto the film. As can be seen from the measurement curves, by means of the coordination of the non-transparent regions in which the light from the LEDs is reflected onto the highly reflective zones 3, the light can be modified as desired before it can exit in the transparent regions after repeated reflection.

If illuminating devices 1 according to FIGS. 5 through 12 are combined with non-transparent regions or particles that are introduced into the cover 5 such as a plastic film, rays of light are reflected back to the zig zag textures by the non-transparent regions or particles. A portion of the rays of light then reflected by the zig zag textures is also reflected onto the highly reflective zones 3. This means that the light from the LEDs, which in itself is highly concentrated and exits with a specific light distribution, is reflected repeatedly both within the cover 5 and also at the highly reflective zones 3. This produces not only a high degree of homogenization and glare reduction of the light, but also allows a targeted focusing and distribution of the light exiting from the cover 5 or the plastic film.

Other alternative embodiments of the cover 5 are also possible. Thus, the cover 5 can be embodied with integrated lenses, for example, by means of a targeted local modification of the properties such as the refractive index. For example, a cover 5 can be created from a first plastic in a 3D printing process, wherein the lenses are printed using a second plastic having a different composition. Holographic techniques can also be used to design the cover 5, possibly also in combination with other techniques described above.

1. An illumination device (1) comprising a housing (2), reflective zones (3) on or in the housing (2), at least one illuminating means (4) and a cover (5) with an at least partially transparent material, wherein the illuminating means (4) is arranged inside the housing (2) and the cover (5) is held on the housing (2), characterized in that the at least one illuminating means (4) is embodied as an LED and the cover (5) comprises at least one flat element, particularly a plastic element, which modifies an emission characteristic of the light emitted by the at least one LED.

2. The illuminating device (1) according to claim 1, characterized in that the flat element is embodied on at least one surface with a texture having ridges and recesses, the dimensions of which are larger than a wavelength of the emitted light.

3. The illuminating device (1) according to claim 1, characterized in that the flat element is embodied in sections with non-transparent regions, the dimensions of which are larger than the wavelength of the emitted light.

4. The illuminating device (1) according to claim 1, characterized in that the non-transparent regions are arranged in and/or on the element.

5. The illuminating device (1) according to claim 4, characterized in that the non-transparent regions are arranged in a regular pattern.

6. The illuminating device (1) according to claim 1, characterized in that the cover has a thickness of less than 1 mm, preferably less than 500 μm.

7. The illuminating device (1) according to claim 1, characterized in that multiple illuminating means (4) are provided, wherein the illuminating means (4) are embodied respectively as LEDs and wherein the LEDs are arranged in a tube.

8. The illuminating device (1) according to claim 1, characterized in that the housing (2) is embodied in cross-section with a semicircular mount (21) for a lighting device to which lateral legs (22) with a parabolic profile attach.

9. The illuminating device (1) according to claim 8, characterized in that the legs (22) detachably accommodate the cover (5).

10. The illumination device (1) according to claim 9, characterized in that the legs (22) are embodied at their end side with horizontal projections (23) for accommodating the cover (5).

11. The illuminating device (1) according to claim 1, characterized in that the housing (2) is coated on the inner side with a reflective material.

12. The illuminating device (1) according to claim 1, characterized in that the housing (2) is made of aluminum.

13. The illuminating device (1) according to claim 11, characterized in that a reflection on an inner side of the housing (2) is more than 90%, in particular more than 95%.
